(19) United States
(12) Patent Application Publication
(10) Pub. No.: US 2023/0294253 A1
(43) Pub. Date: Sep. 21, 2023

(54) CLAMP DRIVER DRILL ATTACHMENT

(71) Applicant: Andrew Conley KNIGHT, Austin, TX (US)

(72) Inventor: Andrew Conley KNIGHT, Austin, TX (US)

(21) Appl. No.: 17/654,962

(22) Filed: Mar. 15, 2022

(51) Int. Cl. B25B 13/06; B25B 13/48

(52) U.S. Cl. CPC B25B 13/065; B25B 13/48

(57) ABSTRACT

A drill attachment to facilitate engagement and disengagement of a clamp. A main driver body is configured for attachment to drill such that operation of the drill causes rotation of the driver body and actuates the clamp.

### BACKGROUND AND SUMMARY

The use of clamps is common in many industries. Whether it be in construction, automobile maintenance/repair, plumbing, carpentry, or even general household tasks, clamps have been, and continue to be, an important tool. Despite this importance, the ability to quickly engage or disengage clamps has considerable room for improvement. Most specifically, there is a need for a simple, cost-effective manner to utilize clamps. Conventional approaches to expedite the placement of clamps are often overengineered or too costly for consumer users.

Many clamps utilize the same general design and function. The present disclosure describes a drill attachment that can be used with a conventional automatic hand drill to quickly and efficiently engage or disengage such clamps.

### BRIEF DESCRIPTION OF THE DRAWINGS

FIG. 1 depicts a front view of a clamp driver drill attachment in accordance with embodiments of the present disclosure.

FIG. 2 depicts a perspective view of a clamp driver drill attachment in accordance with embodiments of the present disclosure.

FIG. 3 depicts a sectional view of a clamp driver drill attachment in accordance with embodiments of the present disclosure.

FIG. 4 depicts a bottom view of a clamp driver drill attachment in accordance with embodiments of the present disclosure.

FIG. 5 depicts a top view of a clamp driver drill attachment in accordance with embodiments of the present disclosure.

FIG. 6 depicts a perspective view of a clamp driver drill attachment engaged to a hand drill in accordance with embodiments of the present disclosure.

FIG. 7 depicts a perspective view of a clamp driver drill attachment engaged to a C-clamp in accordance with embodiments of the present disclosure.

FIG. 8 depicts a perspective view of various body designs of a clamp driver drill attachment in accordance with embodiments of the present disclosure.

FIG. 9 depicts a perspective view of a clamp driver drill attachment in accordance with embodiments of the present disclosure.

### DETAILED DESCRIPTION

This description, with references to the figures, presents non-limiting examples of embodiments of the present disclosure.

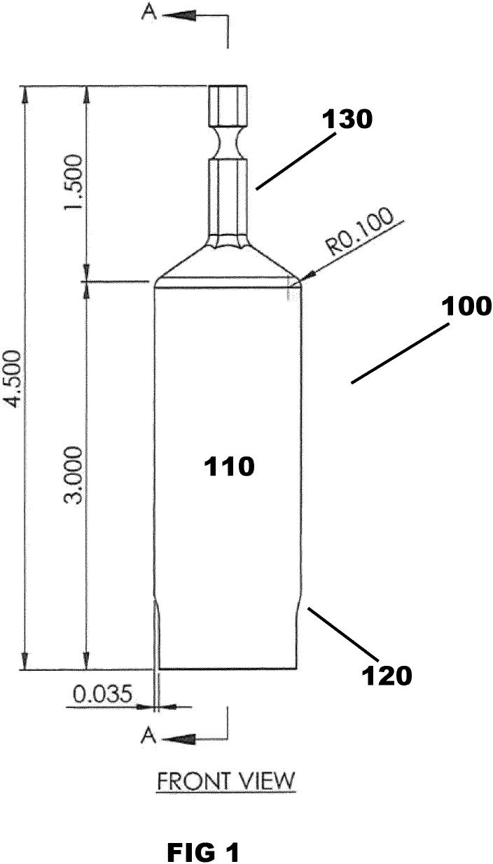

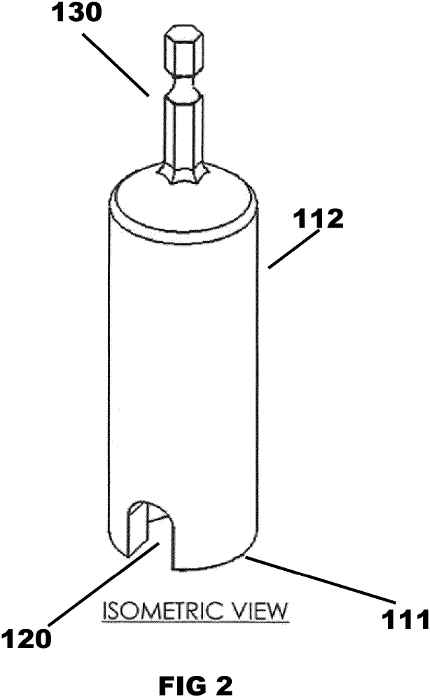

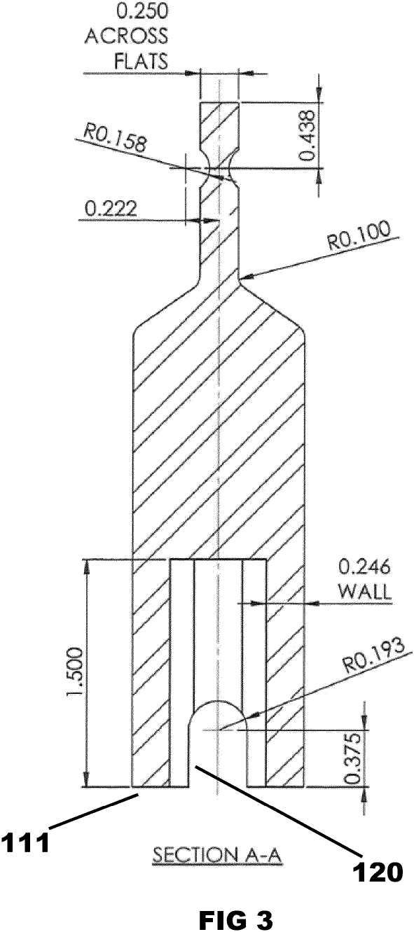

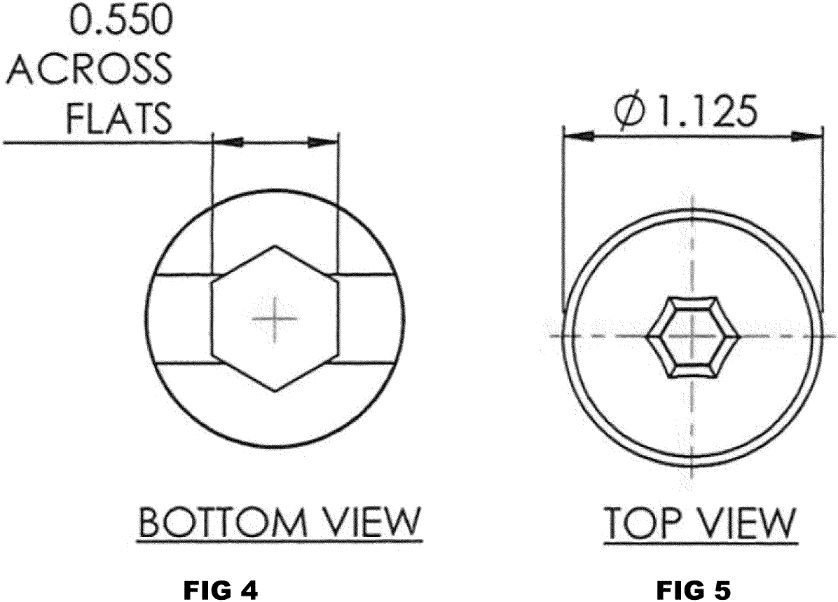

As depicted in at least FIGS. 1-3, in certain embodiments of the present disclosure, a clamp driver drill attachment 100 includes a main body portion 110. Main body portion 110 may have a first end 111 positioned substantially opposite a second end 112. There may be a connector element 130 disposed in substantially the center of second end 112. Connector element 130 may be configured to attach to, or otherwise engage with, a conventional automatic hand drill such that operation of the drill will cause main body portion 110 to rotate.

In some embodiments, main body portion 110 may be substantially hollow. In other embodiments, main body portion 110 may be substantially solid. In even further embodiments, main body portion 110 include a non-hollow segment and a hollowed segment wherein the hollowed segment is disposed at first end 111. There may be at least one recessed portion 120 of main body portion 110 arranged near the edge of first end 111. The at least one recessed portion 120 may be configured to engage with the movable jaw driving mechanism (such as a screw or crossbar) of a clamp (such as a C-clamp, F-clamp, or other conventional clamp) such that, when connector element 130 is engaged with a hand drill, operation of the hand drill will cause the movable jaw driving mechanism to actuate. The at least one recessed portion 120 may include two recessed portions disposed substantially opposite one another and define a recessed channel through main body portion 110 to facilitate engagement with a movable jaw driving mechanism of a conventional clamp. In such embodiments, a first recess may be configured to receive a first segment of a clamp crossbar while a second recess is configured to receive a second segment of the clamp crossbar. The recessed channel may be partially defined by the hollowed, interior volume of main body portion 110.

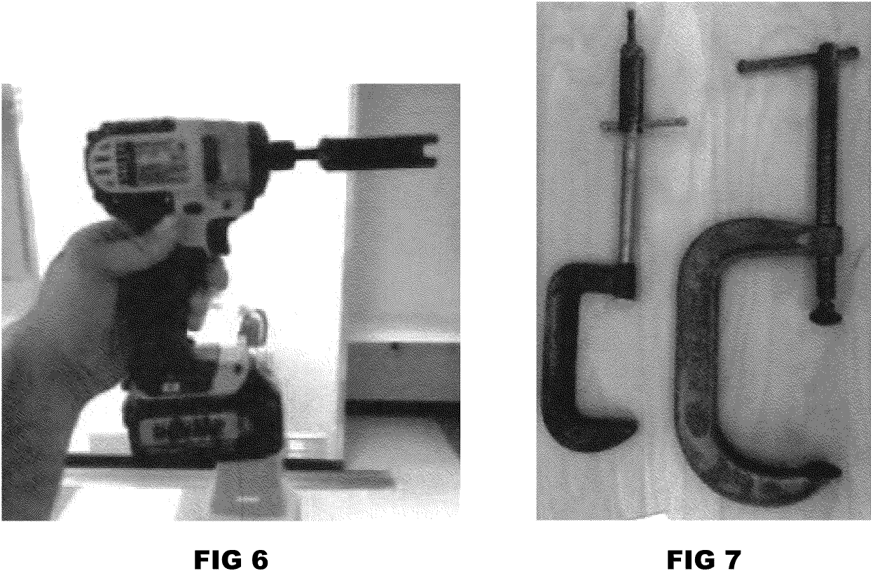

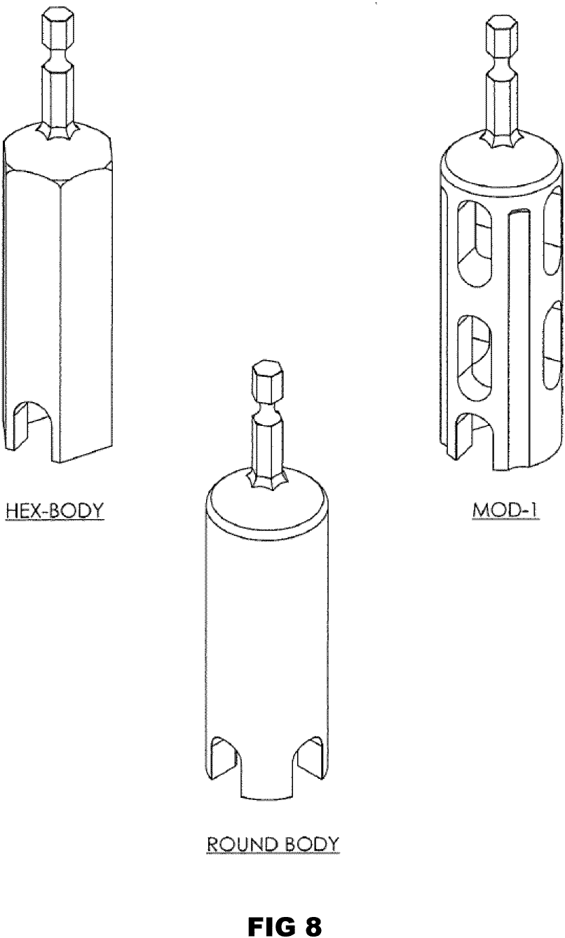

To use a clamp driver drill attachment in accordance with embodiments of this disclosure, as shown in FIG. 6, connector element 130 may be fitted into the chuck of an automatic hand drill. At least one recessed portion 120 may then receive a movable jaw driving mechanism as shown in FIG. 7. By operating the hand drill, the rotation of main body portion 110 via connector element 130 will cause the movable jaw driving mechanisms to actuate and secure the clamp as desired by the operator.

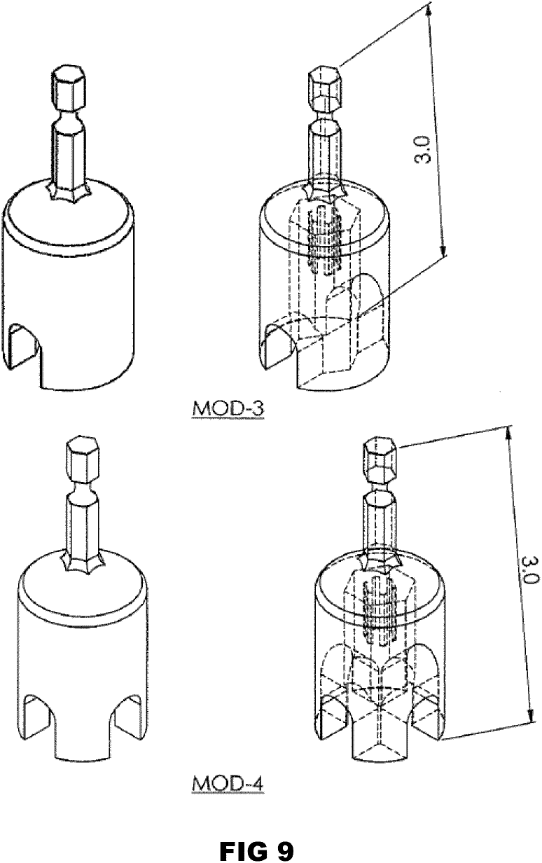

As depicted in FIGS. 8-9, main body portion 110 may be of varying shapes or geometries including a substantially cylindrical or hexagonal structure. Main body portion 110 may be composed of a rigid material such as impact grade steel, other metal or metal alloys, and rigid polymers.

Although the disclosure has been explained in relation to various embodiments thereof, it is to be understood that many other possible modifications and variations can be made without departing from the spirit and scope of the disclosure.

1. A clamp driver drill attachment comprising:
a clamp driver element having a first end, a second end, and a main body portion disposed between said first end and said second end;
at least one aperture in said main body portion at said first end, wherein said at least one aperture is configured to engage with a clamp jaw actuator; and
a connector element disposed at said second end of said main body portion, said connector element being configured to couple with a drill.

2. The clamp driver drill attachment of claim 1 wherein said at least one aperture is a first groove and a second groove, wherein said first groove and said second groove are disposed substantially opposite one another relative said main body portion and partially define a channel through said main body portion.

3. The clamp driver drill attachment of claim 2 wherein said connector element is disposed substantially centrally upon a connector face at said second end of said main body portion.

4. The clamp driver drill attachment of claim 3 wherein said main body portion is composed of rigid metal.

5. The clamp driver drill attachment of claim 3 wherein said main body portion is substantially cylindrical in shape.

6. The clamp driver drill attachment of claim 3 wherein said main body portion is substantially hexagonal in shape.
